(19) United States
(12) Patent Application Publication
(10) Pub. No.: US 2004/0207993 A1
(43) Pub. Date: Oct. 21, 2004

(54) Indicator light comprising an optical piece fulfilling an indicating function in a self-contained manner

(76) Inventors: Jean-Pierre Aynie, Bobigny (FR); Benoist Fluery, Bobigny (FR); Norbert Brun, Bobigny (FR)

Correspondence Address: MORGAN & FINNEGAN, L.L.P., 3 WORLD FINANCIAL CENTER, NEW YORK, NY, 10281-2101, US

(21) Appl. No.: 10/449,044

(22) Filed: May 29, 2003

(30) Foreign Application Priority Data
May 31, 2002 (FR) 0206756

(51) Int. Cl. G01D 11/28

(52) U.S. Cl. 362/23

(57) ABSTRACT

The invention proposes an indicator light, in particular for a motor vehicle, of the type comprising a central optical axis oriented from rear to front, a light source on this optical axis, and a solid optical piece, of the type in which the optical piece comprises an input surface and an output surface,

wherein the optical piece comprises a roughly transverse reflection surface which is arranged axially opposite the output surface;

and in that the input surface is arranged axially between the reflection surface and the output surface,

so that the light rays which enter the optical piece through the input surface are reflected by the reflection surface to the output surface.

### FIELD OF THE INVENTION

The invention proposes an indicator light in particular for a motor vehicle.

### BACKGROUND OF THE INVENTION

The invention proposes more particularly an indicator light, especially for a motor vehicle, of the type comprising a central optical axis oriented from rear to front, in the direction of propagation of the light beam emitted by the light, a roughly point light source disposed on this optical axis, and a solid optical piece, at least partly of revolution about the optical axis, which is produced from a transparent material with a refractive index higher than that of air, of the type in which the optical piece comprises an input surface, and an output surface which is transverse overall and which is designed to transmit the light rays towards the front, in a direction roughly parallel to the optical axis, so as to fulfil a given indicating function.

This type of indicator light generally requires a substantially parabolic reflector disposed axially to the rear of the optical piece in order to collect the light rays emitted by the light source and to concentrate them on the input surface of the optical piece.

When it is wished to produce an indicator light with a low axial thickness, for example around seven to eight millimetres, the structure of the parabolic reflector limits the front opening of the indicator light, that is to say the area of the output surface. The small axial thickness of the light therefore entails a small output surface, so that the luminance of the light per unit of surface is high.

However, when a rear indicating function is being fulfilled, unlike a front lighting function, the persons in the vehicles following the vehicle equipped with the said indicator light often need to turn their gaze in the direction of the light source. It is therefore important to minimise the luminance of the light per unit of surface, with a view to avoiding dazzling the said persons.

In addition, the indicator lights of known types are not adapted to the use of a small light source, such as a light emitting diode, which emits its light flux in a solid angle of given value, less than one hundred and eighty degrees. This is because the light sources conventionally used in indicator lights are filament lamps which emit light roughly in all directions from the filament.

The invention aims to remedy the aforementioned drawbacks by proposing an indicator light which can have a small axial thickness whilst having sufficient output surface to fulfil the indicating function and which is adapted to the use of a light source such as a light emitting diode.

The invention also aims to minimise the number of parts necessary for fulfilling the indicating function and to minimise the manufacturing cost.

### SUMMARY OF THE INVENTION

For this purpose, the invention proposes an indicator light of the type described above, characterised in that the optical piece comprises a roughly transverse reflection surface which is arranged axially opposite the output surface and in that the input surface is arranged axially between the reflection surface and the output surface so that the light rays which enter the optical piece through the input surface are reflected by the reflection surface to the output surface.

According to other characteristics of the invention:

the light source is arranged at least partially between the reflection surface and the output surface;

the light source is a light emitting diode comprising a light diffusion globe;

the input surface has roughly the shape of a concave spherical cap whose centre coincides roughly with the core of the light source, so that the light rays emitted by the source enter the optical piece, overall without being refracted;

the light diffusion globe has the shape of a convex spherical cap whose centre coincides roughly with the centre of the input surface;

the reflection surface is coated with a layer of reflective material, for example a layer of aluminium;

the reflection surface comprises reflection rings which are inclined towards the optical axis and towards the front;

the output surface is formed by a series of separation surfaces which become the light rays coming from the reflection surface, so that the light rays are emitted forwards in a direction roughly parallel to the optical axis;

the input surface is oriented towards the rear, and the output surface comprises at least one annular part whose generatrix describes an angle of inclination, with respect to the optical axis, such that the light rays emitted by the source are reflected on this annular part, in accordance with the principle of total reflection, towards the reflection surface;

the output surface comprises a central part roughly in the form of a convex spherical cap whose centre is offset axially towards the rear, with respect to the centre of the input surface, so that the light rays emitted by the source which reach the central part are refracted forwards in a direction substantially parallel to the optical axis;

the central part defines, with the source, a solid angle of given value, which contains overall the light rays whose angle of inclination with respect to the angle of inclination of the generatrix of the annular part is insufficient to allow their total reflection on the output surface;

the input surface is oriented towards the front, and the reflection surface comprises at least one annular part whose generatrix describes an angle of inclination, with respect to the optical axis, such that the light rays emitted by the source are reflected on this annular part, in accordance with the principle of total reflection, towards the output surface.

Other characteristics and advantages of the invention will emerge from a reading of the following detailed description, for an understanding of which reference will be made to the accompanying drawings, amongst which:

### BRIEF DESCRIPTION OF THE DRAWINGS

FIG. 1 is a three-quarters exploded perspective view with cutaway which depicts an indicator light produced in accordance with the teachings of the invention according to a first embodiment;

FIG. 2 is a view in axial section which shows the indicator light of FIG. 1;

FIG. 3 is a view similar to that in FIG. 2 which depicts an indicator light produced in accordance with the teachings of the invention according to a second embodiment.

### DESCRIPTION OF THE PREFERRED EMBODIMENTS

In the following description, substantially identical or similar elements will be designated by identical references.

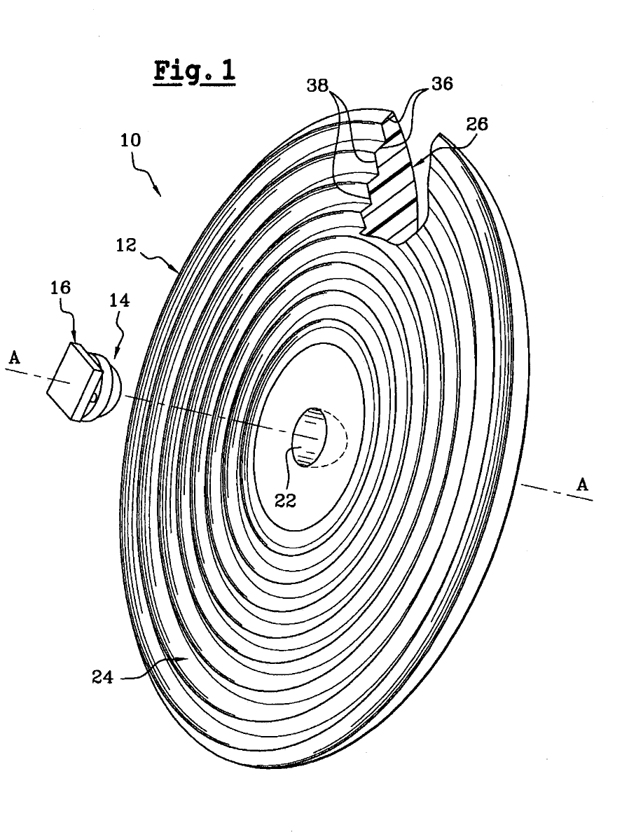

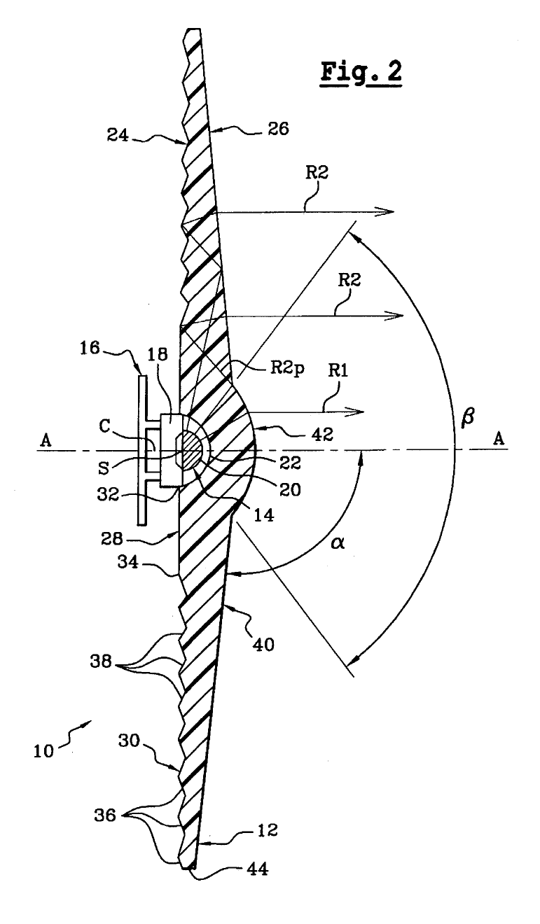

FIGS. 1 and 2 depict an indicator light 10 which is produced in accordance with a first embodiment of the invention.

This indicator light 10 comprises a solid optical piece 12 which serves both as a light flux recuperator and a light flux diffuser for a roughly point light source, consisting here of a light emitting diode 14.

The diode 14 has been shown mounted on a support plate 16, at the rear, which in particular allows its connection to an electrical supply system and to a control unit (neither being shown).

The diodes 14 are available in several colours, that is to say it is possible to choose the colouring of the light flux emitted by the diode 14. The colour of the diode 14 is preferably chosen according to the indicating function to be fulfilled, for example red for a fog light function or white for a reversing light function.

The optical piece and the diode 14 are arranged coaxially along a central optical axis A-A which extends roughly horizontally from left to right, looking at FIG. 2.

In the remainder of the description, use will be made non-limitingly of an axial orientation from rear to front which corresponds to an orientation from left to right along the optical axis A-A.

Non-limitingly, elements will be referred to as external or internal depending on whether they are arranged radially towards the optical axis A-A or in the opposite direction to this axis.

Referring in particular to FIG. 2, it can be seen that the diode 14 comprises at the rear a substantially cylindrical connection box 18 and at the front a substantially hemispherical light diffusion globe 20 centred on the optical axis A-A, convex towards the front.

The connection box 18 comprises fixing and electrical connection means (not shown) for mounting the diode 14 on the plate 16.

In the following description, it is considered, in an approximate fashion, that the diode 14 is a point light source S which emits light rays radially, roughly towards the front, from the centre S of the hemisphere forming the globe 20.

The centre S corresponds roughly to the core of the light source, that is to say the point of the source from which the major part of the light flux seems to come.

Advantageously a diode 14 is chosen whose aperture is close to 180 degrees, that is to say it emits light rays at a solid angle of 180 degrees, centred around the optical axis A-A.

The optical piece 12 is a shape of revolution about the optical axis A-A and is produced from a transparent material having a refractive index higher than that of air, which here constitutes the ambient environment surrounding the piece 12.

The optical piece 12 is advantageously produced in a single piece by moulding from a transparent plastic material such as, for example, polymethyl methylacrylate (PMMA).

The optical piece 12 comprises an input surface 22, a reflection surface 24 and an output surface 26.

The input surface 22 has here a concave hemispherical shape whose centre coincides roughly with the centre S of the light source 14.

The reflection surface 24 extends roughly in a plane transverse to the optical axis A-A, passing through the centre S of the light source 14.

The reflection surface 24 has the form of a ring centred on the optical axis A-A, which comprises an optically neutral internal annular part 28 and an external annular part 30. The two annular parts 28, 30 are contained overall in the same transverse plane.

The internal annular part 28 is flat and extends transversely towards the outside, from the peripheral edge 32 of the input surface 22 as far as the internal peripheral edge 34 of the external annular part 30.

The external annular part 30 is formed by a series of reflective rings 36 which are coaxial along the optical axis A-A.

The external annular part 30 is designed overall according to the same principle as a lens of the drum type.

The generatrix of each reflective ring 36 is a straight line segment which is inclined towards the front and towards the optical axis A-A.

The reflective rings 36 are stepped radially towards the outside, two successive reflective rings 36 being separated by an optically neutral ring 38.

The generatrix of each neutral ring 38 is here a straight line segment which is inclined towards the front and towards the outside.

According to the embodiment depicted here, the generatrices of the reflective rings 36 are substantially parallel, and the length of these generatrices decreases progressively on moving away from the axis A-A.

According to this embodiment, the acute angle which defines each generatrix of a neutral ring 38 with the optical axis A-A increases progressively on moving away from the axis A-A.

The reflection surface 28 is covered, on its rear face, with a layer of reflective material, for example based on aluminium, so that the light rays which are transmitted inside the optical piece 12 and which reach the reflective rings 38 are reflected towards the output surface 26.

The reflective material can be deposited solely on the reflective rings 36 since only the reflective rings 36 are intended to reflect the light rays which participate in the indicating function.

The output surface 26 of the optical piece 12 extends overall in a transverse plane, axially opposite the reflection surface 24.

The output surface 26 comprises an annular part 40 whose generatrix is a straight line segment which describes an angle of inclination α, with respect to the optical axis A-A, so as to form overall a truncated cone whose apex is at the front.

According to a variant embodiment (not shown), the generatrix of the annular part 40 can be an arc of a circle so as to form a convex spherical cap.

The output surface 26 comprises a central part 42 in the form of a convex spherical cap which is centred on the optical axis A-A.

The centre C of the central part 42 is advantageously offset axially towards the rear with respect to the centre S of the input surface 22.

The central part 42 defines, with the centre S of the light source 14, a solid angle β of given value.

The value of the solid angle β is determined according to the angle of incidence of the light rays which are emitted by the source 14 and which directly reach the output surface 26 after having passed through the input surface 22.

The value of the solid angle β must be such that the central part 42 collects all the light rays whose angle of inclination, with respect to the angle of inclination of the generatrix of the annular part 40, is insufficient to allow their total reflection towards the rear.

The value of the solid angle β is for example approximately one hundred degrees.

According to the embodiment depicted here, the outside diameter of the external annular part 30 of the reflection surface 24 is equal to the outside diameter of the annular part 40 of the output surface 26. The optical piece 12 therefore comprises a peripheral cylindrical surface 44 which connects the reflection surface 24 to the output surface 26.

It will be noted that the input surface 22 is interposed axially between the reflection surface 24 and the output surface 26.

The light source 14 is here arranged axially between the reflection surface 24 and the output surface 26.

The functioning of the indicator light 10 according to the first embodiment of the invention is now described.

The whole of the optical system consisting of the diode 14 and the optical piece 12 being overall of revolution about the optical axis A-A, the optical functioning will be explained solely in the axial half-plane which is depicted in FIG. 6.

To facilitate understanding of the invention, only some of the light rays emitted by the diode 14 have been shown in FIG. 6.

The majority of the light rays R are emitted by the source 14 in radial directions with respect to the input surface 22 since the light source 14 is substantially a point source and located at the point S. Consequently these rays R enter the optical piece 12 by passing through the input surface 22 without being refracted.

The majority of the light energy produced by the source 14 is therefore transmitted inside the optical piece 12.

Amongst the light rays R which enter the optical piece 12, the rays R1, whose direction of transmission is included in the solid angle β, reach the central part 42 of the output surface 26.

These light rays R1 are refracted through the central part 42 and are emitted towards the front in directions substantially parallel to the optical axis A-A.

It will be noted that the central part 42 of the output surface 26 functions like a convergent lens whose focus is the centre S of the light source 14.

The rays R2 whose direction of transmission is not included in the solid angle β, reach the annular part 40 of the output surface 26.

Because of the design of the output surface 26, and in particular because of the angle of inclination αof the generatrix of the annular part 40, the light rays R2, which are emitted by the source 14 and which reach the annular part 40, directly after having passed through the input surface 22, are reflected on this annular part 40, in accordance with the principle of total reflection, towards the reflective rings 36 of the external annular part 30 of the reflection surface 24.

The rays R2 are reflected on the reflective rings 36 and are sent back towards the annular part 40 of the output surface 26.

The angle of inclination αof the generatrix of the annular part 40 is chosen so that, after being reflected on the reflective rings 36, the light rays R2 pass through the annular part 40 whilst being refracted forwards, in a direction substantially parallel to the optical axis A-A.

The rings 38 of the external annular part 30 of the reflection surface 24 are optically neutral, that is to say they have no optical function, since they cannot be reached by the light rays R2 reflected on the annular part 40 of the output surface 26.

The diameter of the peripheral edge 34 of the external annular part 30 is determined overall by the point of impact, on the reflection surface 24, of the light ray R2p closest to the solid angle β. This is because, the closer a light ray R2 is to the solid angle β, the closer its point of impact on the reflection surface 24 is to the optical axis A-A.

Thus the internal annular part 28 of the reflection surface 24 does not receive the light rays R2 which are reflected on the annular part 40 of the output surface 26. It is therefore optically neutral.

It will be noted that the staging of the reflective rings 36 makes it possible to increase the external diameter of the optical piece 12 and therefore the apparent light surface which fulfils the indicating function, with a view to preventing any nuisance by dazzling to any persons who may need to look in the direction of the indicating light 10.

The transverse dimension of the central part 42 of the output surface 26 is determined mainly by the axial depth of the optical piece 12 since this value is related to the value of the solid angle β, which is fixed.

Preferably, a small axial depth of the optical piece 12 is chosen so that the area of the central part 42 of the output surface 26 is very much less than the area of the annular part 40. The annular part 40 occupies for example eighty percent of the output surface 26.

The invention makes it possible, for example, to produce an indicator light 10 whose axial depth is less than thirty millimetres, for a front opening, that is to say for a transverse dimension at the output of the light 10, of at least eighty millimetres.

Advantageously each reflective ring 36 is faceted, that is to say it comprises a series of elementary reflection facets (not shown), which are for example adjacent to one another circumferentially. Each facet is designed to spatially distribute the light rays towards the front so that the indicator light 10 forms at the front a lighting beam fulfilling a chosen regulatory indicating function.

For example, if the indicator light 10 is designed to fulfil a fog-light function, for which the light beam must have a diamond shape, then this facet has an optimised profile for producing, at the front of the indicator light 10, on a measuring screen, an image roughly in the shape of a diamond.

The diamond is not regular, it must have a height, along a vertical axis, less than its width, along a horizontal axis. The profile of each facet must therefore be optimised to make it possible to produce on the measuring screen a shape which approaches the diamond sought for here.

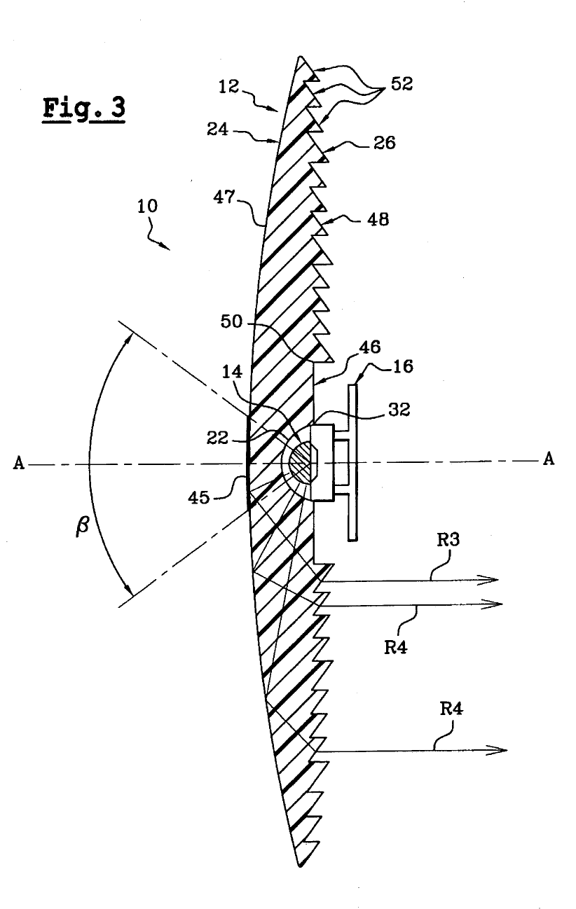

FIG. 3 depicts a second embodiment of the invention.

In the following description the differences in structure and functioning of the second embodiment with respect to the first will mainly be described.

An important difference with respect to the first embodiment is the arrangement of the input surface 22 and therefore of the light source 14, here a light emitting diode similar to that of the first embodiment, at the front of the optical piece 12.

The input surface 22 and the light source 14 of the second embodiment are arranged symmetrically respectively with respect to the input surface 22 and to the light source 14 of the first embodiment, in a symmetry with respect to a transverse plane.

It should be noted that, in the second embodiment, as the light source 14 is arranged on the side of the output surface 26, the electrical supply to the light source 14 is more complex to design since it must be effected through the front of the light 10. It may be necessary, for example, to pass an electric supply cable in front of the output surface 26.

The reflection surface 24 has here the form of a spherical cap centred on the optical axis A-A, whose radius is sufficiently great so that the reflection surface 24 is transverse overall, and whose axial depth is substantially equal to the axial depth of the optical piece 12.

The external peripheral edge of the reflection surface 24 is here connected directly to the external peripheral edge of the output surface 26.

The radius of the reflection surface 24 and the axial distance between the reflection surface 24 and the source 14 are chosen so that the majority of the light rays emitted by the source 14 are reflected on the reflection surface 24 in accordance with the principle of total reflection.

By design, the light rays R3 which are contained in a solid angle β of given value, as from the source 14, cannot have a sufficient angle of inclination, with respect to the reflection surface 24, to be reflected in accordance with the principle of total reflection on the reflection surface 24.

The solid angle β delimits, in the reflection surface 24, a central part 45 and an annular part 47.

Advantageously, the rear face of the central portion 45 is covered with a layer of reflective material and comprises reflection facets (not shown) so that the rays R3 which are contained in the solid angle β are reflected towards the output surface 26.

The output surface 26 has the form of a ring, centred on the optical axis A-A, which comprises an optically neutral internal part 46 and an external annular part 48.

The internal annular part 46 is flat and extends transversely outwards, from the peripheral edge 32 of the input surface 22, as far as the internal peripheral edge 50 of the external annular part 48.

The external annular part 48 of the output surface 26 is produced here in the form of a Fresnel lens which comprises a series of concentric annular separation surfaces 52.

The functioning of the light 10 according to the second embodiment is as follows.

It should be noted that, according to the second embodiment of the invention, all the light rays R emitted by the diode 14, after having passed through the input surface 22, are first of all reflected on the reflection surface 24 before passing through the output surface 26.

The light rays R4 which are emitted outside the solid angle β are reflected on the annular part 47 of the reflection surface 24, in accordance with the principle of total reflection, and then reach the external annular part 48 of the output surface 26.

Passing through the external annular part 48, the light rays R4 are refracted by the separation surfaces 52 so that they are emitted forwards in a direction substantially parallel to the optical axis A-A, in order to fulfil the indicating function.

The light rays R3 which reach the central part 45 of the reflection surface 24 are reflected towards the external annular part 48 of the output surface 26, where they are refracted by the separation surfaces 52 towards the front.

It should be noted that the internal annular part 46 of the output surface 26 is optically neutral since it does not receive any light rays coming from the diode 14.

The invention therefore makes it possible to produce an indicator light 10 comprising a large output surface 26 with a small axial dimension.

In addition, the indicator light 10 according to the invention makes it possible to use the majority of the light flux emitted by a point source, such as a diode 14, in order to fulfil a regulatory indicating function.

In the indicator light 10 according to the invention, the optical piece 10 is optically “self-contained”, that is to say it fulfils the indicating function by itself, without its being necessary to add a reflector and/or a diffusion glass.

The optical piece 12 according to the invention achieves both the recuperation of the light rays emitted by the source 14 and the distribution of the light rays forwards so as to fulfil the chosen indicating function.

Naturally, the indicator light 10 according to the invention can be arranged inside a casing comprising an external protective glass, for example in a casing which groups together all the indicator lights associated with the various regulatory functions.

What is claimed is:

1. Indicator light, especially for a motor vehicle, of the type comprising a central optical axis oriented from rear to front, in the direction of propagation of the light beam emitted by the light, a roughly point light source disposed on this optical axis, and a solid optical piece, at least partly of revolution about the optical axis, which is produced from a transparent material with a refractive index higher than that of air, of the type in which the optical piece comprises an input surface, and an output surface which is transverse overall and which is designed to transmit the light rays towards the front, in a direction roughly parallel to the optical axis, so as to fulfil a given indicating function,
wherein the optical piece comprises a roughly transverse reflection surface which is arranged axially opposite the output surface;
and wherein the input surface is arranged axially between the reflection surface and the output surface,
so that the light rays which enter the optical piece through the input surface are reflected by the reflection surface to the output surface.

2. Indicator light according to claim 1, wherein the light source is arranged at least partially between the reflection surface and the output surface.

3. Indicator light according to claim 1, wherein the light source is a light emitting diode comprising a light diffusion globe.

4. Indicator light according to claim 1, wherein the input surface has roughly the shape of a concave spherical cap whose centre coincides roughly with the core of the light source, so that the light rays emitted by the source enter the optical piece, overall without being refracted.

5. Indicator light according to claim 4, wherein the light source is a light emitting diode comprising a light diffusion globe that has the shape of a convex spherical cap whose centre coincides roughly with the centre of the input surface.

6. Indicator light according to claim 1, wherein the reflection surface is coated with a layer of reflective material, for example a layer of aluminium.

7. Indicator light according to claim 6, wherein the reflection surface comprises reflection rings which are inclined towards the optical axis and towards the front.

8. Indicator light according to claim 1, wherein the output surface is formed by a series of separation surfaces which become the light rays coming from the reflection surface, so that the light rays are emitted forwards in a direction roughly parallel to the optical axis.

9. Indicator light according to claim 1, wherein the input surface is oriented towards the rear, and the output surface comprises at least one annular part whose generatrix describes an angle of inclination, with respect to the optical axis, such that the light rays emitted by the source are reflected on this annular part, in accordance with the principle of total reflection, towards the reflection surface.

10. Indicator light according to claim 9, wherein the input surface has roughly the shape of a concave spherical cap whose centre coincides roughly with the core of the light source, so that the light rays emitted by the source enter the optical piece, overall without being refracted and wherein the output surface comprises a central part roughly in the form of a convex spherical cap whose centre is offset axially towards the rear, with respect to the centre of the input surface, so that the light rays emitted by the source which reach the central part are refracted forwards in a direction substantially parallel to the optical axis.

11. Indicator light according to claim 10, wherein the central part defines, with the source, a solid angle of given value, which contains overall the light rays whose angle of inclination with respect to the angle of inclination of the generatrix of the annular part is insufficient to allow their total reflection on the output surface.

12. Indicator light according to claim 8, wherein the input surface is oriented towards the front, and in that the reflection surface comprises at least one annular part whose generatrix describes an angle of inclination, with respect to the optical axis, such that the light rays emitted by the source are reflected on this annular part, in accordance with the principle of total reflection, towards the output surface.
